(19) United States
(12) Patent Application Publication
(10) Pub. No.: US 2022/0023986 A1
(43) Pub. Date: Jan. 27, 2022

(54) CNC MACHINE, WORKSTATION AND COMPONENTS

(71) Applicant: Mark Cherpurny, Bradford (CA)

(72) Inventor: Mark Cherpurny, Bradford (CA)

(21) Appl. No.: 17/338,448

(22) Filed: Jun. 3, 2021

Related U.S. Application Data
(63) Continuation-in-part of application No. 16/866,381, filed on May 4, 2020.
(60) Provisional application No. 62/842,243, filed on May 2, 2019.

(51) Int. Cl. B23Q 1/01; B23C 1/12; B23C 1/06

(52) U.S. Cl. CPC B23Q 1/015; B23C 1/12; B23C 2260/76; B23C 2260/04; B23C 1/06

(57) ABSTRACT

A Computer Numerical Control (CNC) machine, including a computer numerical controller, the CNC machine comprising a tool spindle for holding and actuating a tool for contacting a workpiece; a support frame comprising at least one frame element carrying the tool spindle; at least one angle adjustment actuator, coupled to the support frame and the spindle for deflecting an angle of contact of the tool to the workpiece; a motion actuator for causing movement of the tool spindle and tool; an electronic controller for controlling the motion actuator.

### RELATED APPLICATIONS

This application is a continuation-in-part of U.S. application Ser. No. 16/866,381, filed May 4, 2020, entitled “CNC Machine, Workstation And Components, which claims the benefit of U.S. Provisional Application No. 62/842,243, filed May 2, 2019, which are hereby incorporated herein by reference in their entireties.

### FIELD OF THE INVENTION

This invention relates to the field of CNC (Computer Numerical Control) machines, including related workstations and components thereof.

### BACKGROUND OF THE INVENTION

There are a variety of cutting machines commonly in use. Among them are lathes, mills, routers and grinders. More recently, such machines have taken the form of CNC (Computer Numerical Control) machines, which are computer controlled for high precision. Such machines typically operate continuously for a substantial period of time, according to how they have been programmed. This is in contrast to a traditional machine being operated by a person, which may make one cut, grind, etc., and then be stopped and repositioned by the operator for the next operation.

High precision is expected from CNC machines because they operate in response to computer programming that governs the movement of the machine. This type of control is to be distinguished from traditional cutting machines operated by a person, where distancers and positioned might just be eyeballed. Even if higher-precision guides and measuring devices are used in such traditional modes of operation, hand operation is expected to be less precise than computer control.

As the computer-numerical programming is controlling the movement of the machine, it is expected that the movement and positioning of the machine, and of the cutting tool, will be very precise. Due to this expectation, there exists a desire to use CNC machines for progressively more precise application. As this trend continues, even greater levels of precision are required, which go beyond those provided by use of computer numerical control. It is not only the control system that affects precision. The structure and composition of the CNC machine can also affect precision.

### SUMMARY OF THE INVENTION

It has been discovered that it is not only the mode of control that affects the precision of CNC machines. One feature that affects precision is the rigidity of the CNC machine's support structure. If that structure has low rigidity, then the displacement or deformation of the structure during operation of the machine will result in reduced precision.

Another factor affecting precision—sometimes related to the previous factor—is the manufacturing tolerances of the components of the CNC machine's support structure. If the elements of the support structure have high tolerances—that is, if there is a wide variation in the actual dimensions of different components that are manufactured to have the same nominal dimensions—then precision will be affected, in part because the tool will tend not to be positioned precisely where the CNC's controller thinks it is positioned.

It is common for CNC machines to use extruded aluminum elements as elements of the support structure, and also as guides for linear motion. With such extruded elements, wheels are required for the linear motion, with the wheels travelling along surfaces of the extruded elements created to support the wheels. Providing such surfaces in turn requires the extruded aluminum elements to have complicated cross-sectional shapes. This is one reason, among several, why extruded aluminum elements have high tolerances, with a consequent loss of precision for the CNC machine.

The use of wheels for linear motion also results in lower precision. Debris from the CNC machine can deflect the wheels as they travel and reduce precision. If there is enough debris, the wheels can get jammed.

It has also been discovered that CNC machines are often complicated and difficult to set up, calibrate and square.

Embodiments of the present invention are understood to address one or more of these or other deficiencies in the prior art.

Therefore, according to an aspect of the present invention there is provided a Computer Numerical Control (CNC) machine, including a computer numerical controller, the CNC machine comprising:

a tool spindle for holding and actuating a tool;

a compound support frame comprising an X-direction support frame for guiding movement of the tool in an X-direction, a Y-direction support frame for guiding movement of the tool in a Y-direction and a Z-direction support frame for guiding movement of the tool in a Z-direction;

the X-direction support frame, Y-direction support frame and Z-direction support frame being (1) operatively coupled to the tool spindle, (2) sized, shaped and mutually positioned to support the tool spindle and tool, and (3) mutually operatively coupled to guide the tool to a three-dimensional range of operating positions;

a motion actuator, operatively coupled to the X-direction support frame, the Y-direction support frame, the Z-direction support frame, and the tool spindle, for causing movement of the tool spindle and tool;

an electronic controller for controlling the motion actuator;

each of the X-direction support frame and Y-direction support frame comprising rigid tubing.

Optionally, the tubing is metal tubing, and optionally, steel tubing.

Optionally, the X-direction support frame comprises at least one metal tube, and the Y-direction support frame comprises at least two metal tubes.

Optionally, the motion actuator comprises;

at least one X-direction ball screw and at least one associated X-direction ball screw motor for rotating the at least one X-direction ball screw;

at least one Y-direction ball screw and at least one associated Y-direction ball screw motor for rotating the at least one Y-direction ball screw;

at least one Z-direction ball screw and at least one associated Z-direction ball screw motor for rotating the Z-direction ball screw.

Optionally, the at least one Y-direction ball screw comprises two Y-direction ball screws, and the at least one Y-direction ball screw motor comprises two Y-direction ball screw motors, each of the Y-direction ball screw motors being associated with a respective Y-direction ball screw.

Optionally, the Y-direction support frame comprises two Y-direction support frame assemblies, each Y-direction support frame assembly comprising at least two Y-direction metal tubes fastened within two Y-direction frame ends, each Y direction frame assembly including a Y-direction carriage, the Y-direction carriages being sized, shaped and positioned to carry the X-direction support frame; the X-direction support frame comprises an X-direction support frame assembly comprising at least two X-direction metal tubes fastened within two X-direction frame ends, the X-direction frame assembly including an X-direction carriage, the X-direction carriage being sized, shaped and positioned to carry the Z-direction support frame; the Z-direction support frame carrying the tool spindle.

Optionally, the metal tubing comprises steel tubing, and/or the X-direction metal tubes and the Y-direction metal tubes comprise steel tubes.

Optionally, the CNC machine further comprises a stiffening assembly fixedly coupled to the X-direction support frame, the Y-direction support frame and the Z-direction support frame, the stiffening assembly comprising a stiffening frame having a solid rigid workpiece fastened thereto.

Optionally, the machine comprises at least one X-direction manual ball screw actuator coupled to the at least one X-direction ball screw, at least one Y-direction manual ball screw actuator coupled to the at least one Y-direction ball screw, and at least one Z-direction manual ball screw actuator coupled to the at least one Z-direction ball screw.

Optionally, the machine comprises a plurality of door gripping flanges, operatively coupled to the compound support frame, for positioning the CNC machine on a door that is oriented in a vertical plane, whereby the CNC machine can work on the door while the door is oriented in a vertical plane.

Optionally, the machine comprises a leg assembly with a plurality of legs, the leg assembly being operatively coupled to the compound support frame, the plurality of legs having a deployed position in which the legs are extended to position the CNC machine generally spaced upward from a floor, and a folded position, whereby the CNC machine may be more easily transported or stored with the legs in the folded position.

Optionally, the leg assembly is fastened to the stiffening frame, the plurality of legs having a deployed position in which the legs are extended to position the CNC machine generally spaced upward from a floor, and a folded position, whereby the CNC machine may be more easily transported or stored with the legs in the folded position.

Optionally, the machine comprises a stand coupled to the compound support frame, the stand being sized, shaped and positioned such that when the stand is engaged the CNC machine stands in a generally vertical plane.

Optionally, the machine comprises two wheels coupled to the compound support frame and positioned such that the CNC machine may be manually pulled with the wheels rolling on a floor to facilitate transport of the CNC machine.

Optionally, the CNC machine comprises a plurality of detachably attachable stiffening rods, said stiffening rods being detachably attachable to said X-direction and Y-direction support frame assemblies, said stiffening rods comprises steel tubing.

According to another aspect of the invention, there is provided a frame assembly module for a CNC machine support structure, the module comprising a frame assembly module support structure, and a traversing element, coupled to the frame assembly module support structure, for traversing the frame assembly module support structure, the traversing element comprising a frame assembly fastening feature for attachment of a second frame assembly module to the traversing element, and a spindle fastening feature of attachment of a spindle to the traversing element, the frame assembly module support structure comprising a traversing element fastening feature for attachment of the frame assembly module support structure to a different traversing block.

### BRIEF DESCRIPTION OF THE DRAWINGS

Reference will now be made, by way of example only, to the figures which illustrate embodiments of the invention, and in which:

FIG. 1 is a perspective view of an embodiment of the frame assembly module.

FIG. 2 is an exploded view of the frame assembly module of FIG. 1.

FIG. 3 is a perspective exploded view of three interconnected modules.

FIG. 4 is a perspective exploded view of a CNC machine.

FIG. 5 is a perspective view of a CNC machine.

FIG. 6 is a perspective view of a CNC machine.

FIG. 7 is a perspective exploded view of a stiffening frame and waste board.

FIG. 8 is a perspective view of a CNC machine with stiffening frame and waste board.

FIG. 9 is a close up view of a frame end.

FIG. 10 is a close up view of a frame end and hand knob.

FIG. 11 shows a CNC machine on a door.

FIG. 12 shows a portion of a folding leg assembly.

FIG. 13 shows a CNC machine, stiffening frame and folding leg assembly.

FIG. 14 shows a CNC machine and folding leg assembly with legs folded.

FIG. 15 shows a CNC machine, folding leg assembly, stand and wheels.

FIG. 16 shows the folded leg assembly folded and resting on a stand.

FIG. 17 shows a frame assembly with stiffening rod.

FIG. 18 shows wall mounting brackets with a bases.

FIG. 19 shows a wall mounted CNC machine.

FIG. 20 is a schematic diagram of controller and motors.

FIG. 21 shows a controller display and mount.

FIG. 22 shows a CNC machine with tool angle adjustment system.

FIG. 22A shows a close up view of the angle adjustment system.

FIG. 23 is a cross-section view of the tool angle adjustment system.

FIG. 24 is an elevation view of a CNC machine support assembly.

FIG. 25 is a perspective view of a CNC machine support assembly.

FIG. 26 is an elevation view of a CNC machine support assembly in a retracted position.

FIG. 27 is a close up of a lock for the CNC machine support assembly.

FIG. 28 is an exploded perspective view of a CNC machine support assembly.

FIG. 29 is a perspective view of a wall mounted CNC machine support assembly.

FIG. 30 is a close up of the wall mounting features.

FIG. 31 is a close up of the wall mounting features in operation.

### DETAILED DESCRIPTION

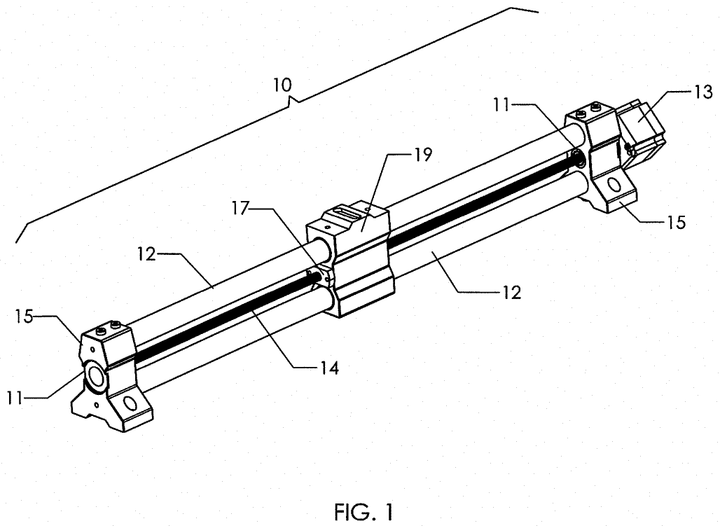

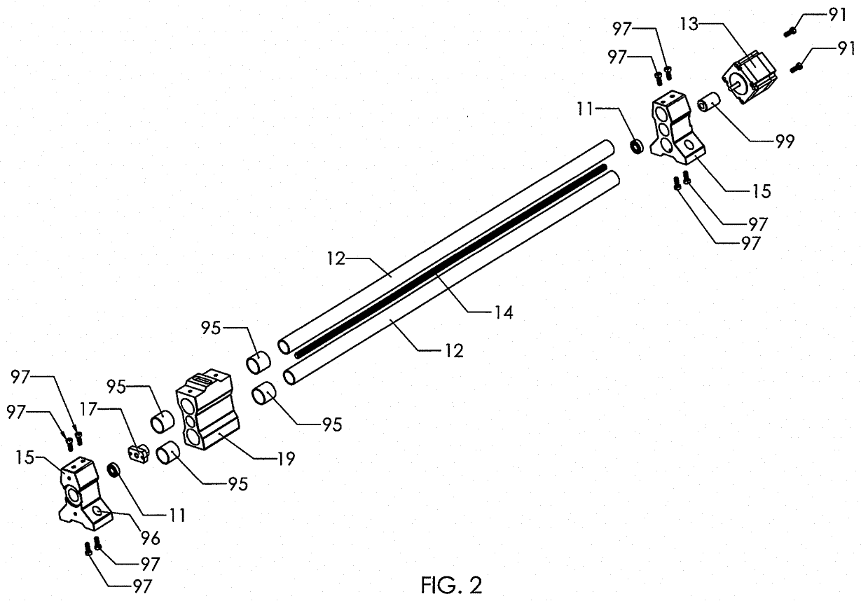

Referring now to FIGS. 1 and 2, a support frame in the form of linear rail assembly 10 is shown. The linear rail assembly comprises two support frame elements 12. The support frame elements extend between, and are held by, frame ends 15, forming a rigid structure. Preferably, frame elements 12 comprise steel tubing, as described in more detail below. It will be appreciated that the linear rail assembly 10 shown in FIG. 1 is preferably a modular component that can inter alia be used in an X-direction support frame as referred to herein, or in a Y-direction support frame as described herein. Each of these support frames may comprise more than one such rail assembly, though in the preferred embodiment the X-direction support frame includes one such assembly 10 and the Y-direction support frame two.

The assembly 10 also includes a linear translator, which preferably takes the form of ball screw 14. Mounted on the two frame elements 12 is a traversing element, optionally in the form of traversing block 19 having ball screw nut 17 mounted thereto. Frame elements 12 extend through traversing block 19, and block 19 is mounted to them via bushings described below. Ball screw 14 is operatively coupled to motor 13, which motor 13 is coupled to one of the frame ends 15. Ball screw 14 extends through the first frame end 15, through ball screw bearing 11 mounted in that same frame end 15, through traversing block 19 and ball screw nut 17 and to the second frame end 15, having a second bearing 11 therein. The motors, ball screws and traversing blocks described herein form part of the motion actuator operatively connected to the support frames described herein for causing movement of the spindle and cutting tool as part of the operation of the CNC machine described herein.

It will be appreciated that, although the preferred embodiment is being described using a cutting tool and cutting tool spindle, the tool need not be a cutting tool, and the spindle may hold a non-cutting tool. For example, and without limitation, the tool may be a laser for engraving, or a marking device (e.g. a permanent marker) that is used to draw. The tool may also comprise a printer head for 3D printing. The tool may also be a cutting tool that is not a bit. For example, the tool may comprise a drag knife to cut vinyl or other fabrics.

It will be appreciated that the frame elements 12, while preferably comprising tubing and most preferably comprising:

Motor 13 is operatively coupled to ball screw 14 to rotate ball screw 14. Ball screw 14 is operatively coupled to nut 17, which is connected to block 19. Thus, traversing block 19 is moved along the frame elements 12 by rotation of the ball screw 14, by means of rotation of the motor 13. Rotation of ball screw 14 causes the threads thereof to exert a force on nut 17 to move block 19. Reversing the direction of rotation of the ball screw 14 reverses the direction of movement of block 19.

Referring further to FIG. 2, motor 13 is coupled to ball screw 14 via coupling 99, positioned within rail end 15. The top and bottom frame elements 12 (preferably in the form of steel tubes) are held to the frame ends 15 by tube mounting screws 97. Motor 13 is coupled to frame end 15 by means of motor mounting screws 91.

Easy change bearings 95 are mounted within traversing block 19, on frame elements 12. The bearings 95 facilitate the movement of the block 19 along the frame elements 12. It will be appreciated that, although a ball screw-bearing combination is preferred, other forms of linear translator are comprehended by the invention. For example, a threaded rod may be used in place of the ball screw, a nut in place of the ball screw nut, and bushings instead of bearings. Ball screws, ball screw nuts and bearings are preferred because ball screws provide high precision movement with lower friction than threaded rods. However, threaded rods may be less expensive, and therefore, there may be applications of the invention for which a user might employ a threaded rod.

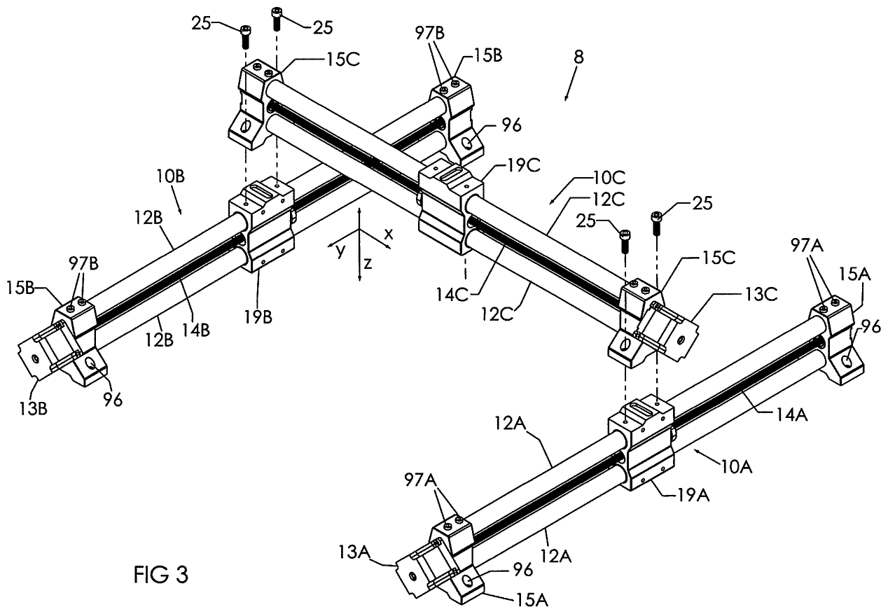

FIG. 3 shows the compound frame assembly 8 which comprises three linear rail assemblies 10 as described above. In FIG. 3, two linear rail assemblies 10A and 10B are disposed parallel to one another. They both extend in a direction that will be called, for illustrative purposes, the Y direction (denoted by the letter Y). Most preferably, the assemblies 10A and 10B are disposed with their ends at the same respective Y positions, to facilitate assembly of the CNC machine. FIG. 3 shows the X, Y and Z directions, mutually orthogonal, for illustrative purposes.

Linear rail assembly 10C is mounted to the blocks 19A and B of each of rail assemblies 10A and 10B. Linear rail assembly 10C is shown, for illustrative purposes, extending along the X-direction. The preferred mounting is accomplished by means of mounting screws 25 that extend through holes in the frame ends 15 of assembly 10C and into blocks 10 of assemblies 10A and 10B. Assemblies 10A, 10B and 10C together permit movement of the cutting tool and cutting spindle in the X-Y plane.

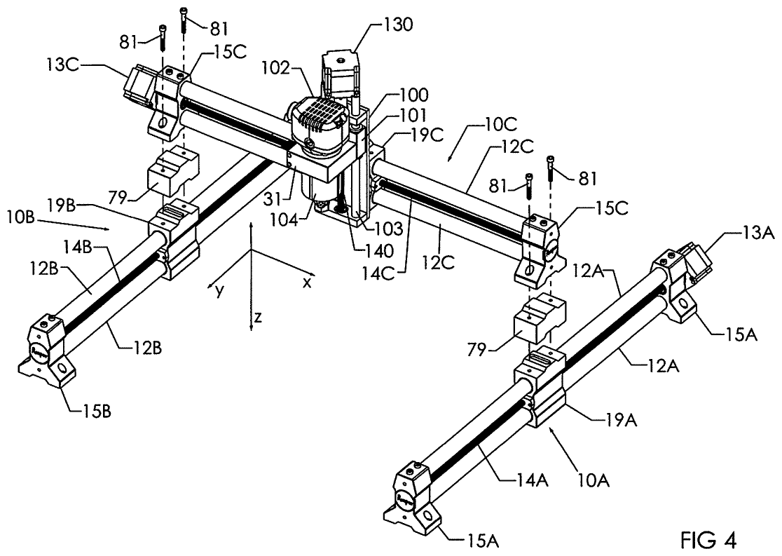

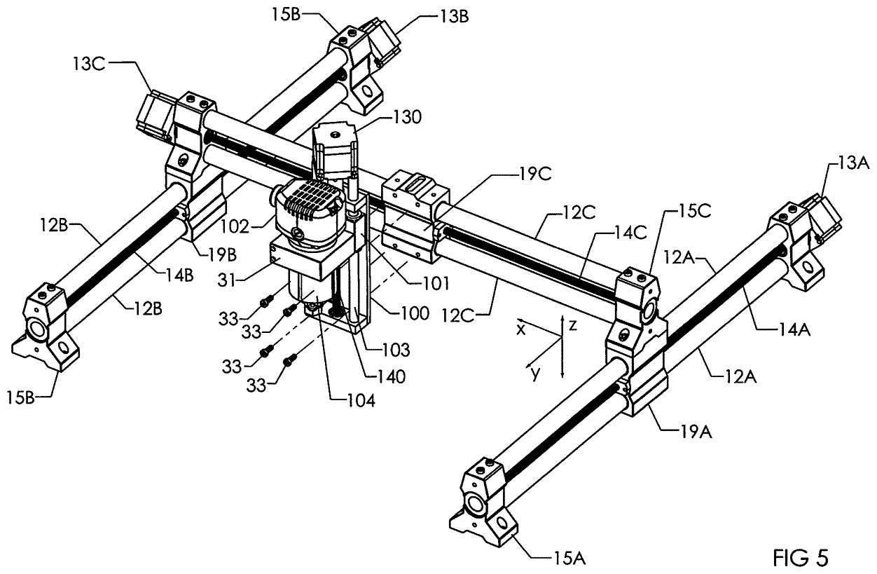

The embodiment shown in FIG. 4 is similar to that shown in FIGS. 3 and 5, except that the compound frame assembly 8 includes risers 79 mounted on traversing blocks 19 of assemblies 10A and 10B. Mounting screws 81 fasten frame ends 15C of assembly 10C to traversing blocks 9 of assemblies 10A and 10B via risers 79. The effect of risers 79 is to raise assembly 10C, and cutting too spindle assembly 31, further above the work surface than they would be without risers 79. This may be useful, for example, if a thick work material is being worked on, or for other reasons.

Referring now to FIG. 5, the mounting of Z-axis spindle assembly 31 to frame assembly 10C is shown. Spindle mounting screws 31 are used to mount spindle assembly 31 to traversing block 19C of assembly 10C. Attached to spindle assembly 10C includes motor 130 driving ball screw 140. Both of these are mounted directly or indirectly to spindle assembly support structure 100 including steel tubing rails 103, which support structure 100 receives screws 33 to be mounted to traversing block 9C. Structure 100 acts as a Z-direction support frame which guides the tool in a Z-direction (typically vertically if the CNC machine is, for example, on a horizontal worktable). Also mounted directly or indirectly to structure 100 are spindle assembly traversing block 101, cutting tool motor 102, and spindle 104 which holds the cutting tool (e.g. a bit, not shown) that works on the workpiece (not shown). Cutting tool motor 102 actuates the working of the cutting tool of the workpiece (e.g. rotating the bit). In the preferred embodiment, the cutting tool is moved toward or away from the workpiece by means of motor 130 rotating ball screw 140. This rotation causes traversing block 101, which carries the cutting tool, to move up and down (i.e. in the Z direction), preferably by means of a ball screw nut (not shown).

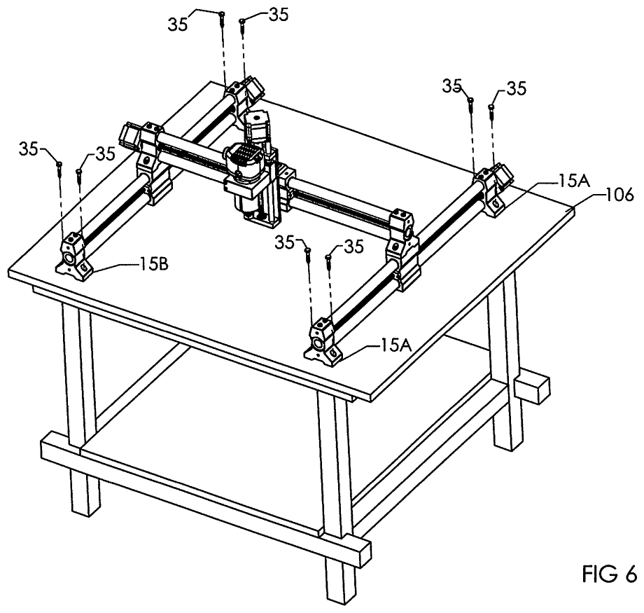

Referring now to FIG. 6, a method of fixing the CNC machine, and in particular the compound frame assembly 8, to a work-table 106 is shown. Mounting screws 35 are used to fasten frame ends 15A and 15B to the work table 106. The frame ends preferably have holes extending in a vertical direction, at right angles to the generally horizontal surface of the work table 106. The holes are configured to receive screws 35 which screws engage the table to fasten the assembly 8 to the work table.

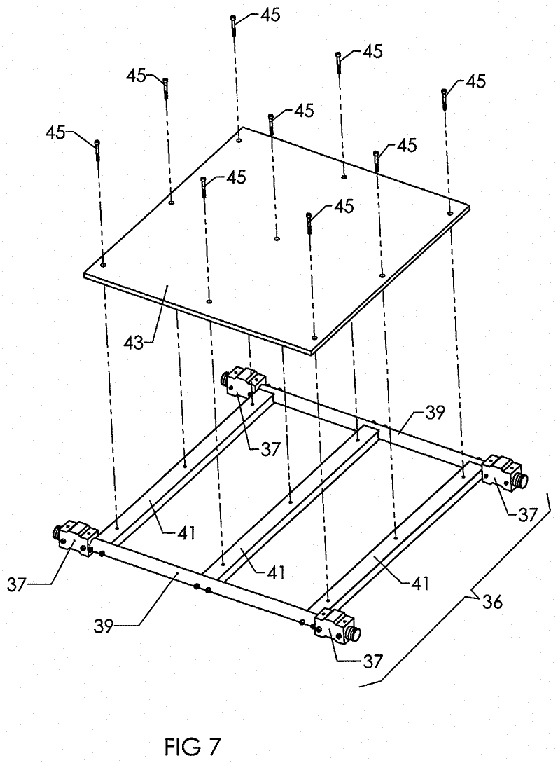

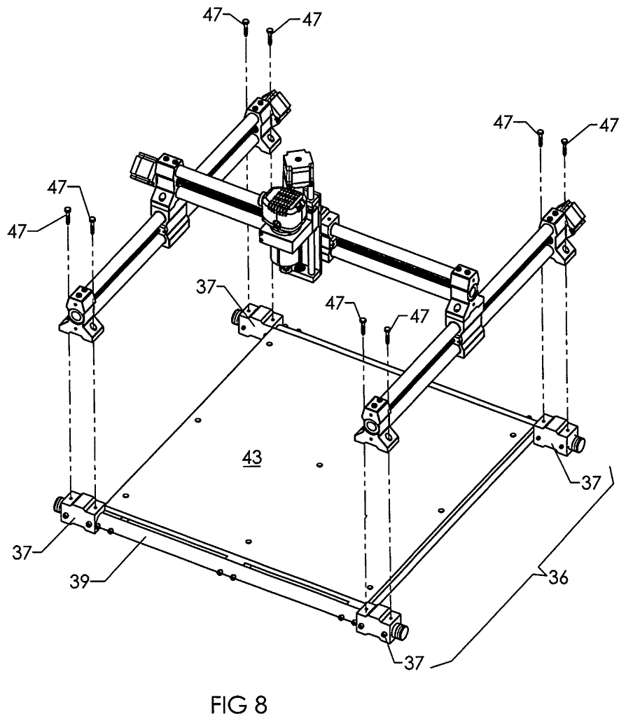

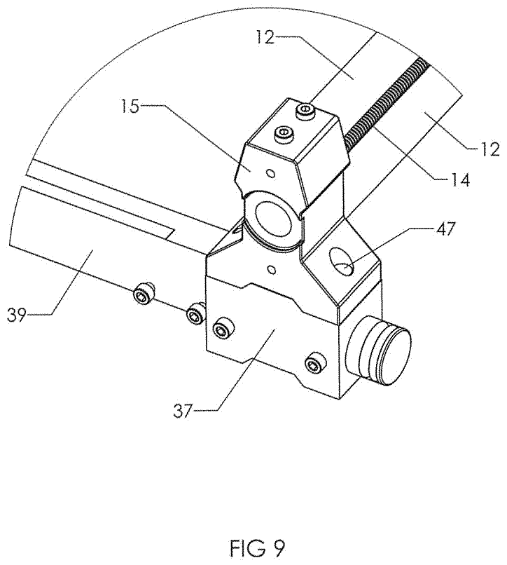

Referring now to FIGS. 7-10 the use of a stiffening frame assembly 36 to stiffen the compound frame assembly 8 is shown. Assembly 36 includes stiffening frame connecting blocks 37, stiffening frame tubes 39, stiffening frame cross braces 41, and wasteboard 43. Waste board 43 is fastened to stiffening frame 36 using stiffening frame mounting screws 45. To help stiffen assembly 8, assembly 8 is fastened to stiffening frame assembly 36. Preferably, this fastening is achieved by using stiffening frame fastening screws 47 to fasten the frame ends 15A and 15B to connecting blocks 37. It will be appreciated that this configuration adds rigidity to assembly 8. There are multiple points of fastening to the stiffening frame. The stiffening frame itself is rigid due to the solid wasteboard and its multiple points of fastening to the stiffening frame assembly 36. In a typical embodiment, frame 36 would be employed with the folding leg assembly referred to below, though other configurations are also possible. It will be appreciated that the increased stiffening/rigidity of the CNC machine related to this feature provides increased precision, as described herein.

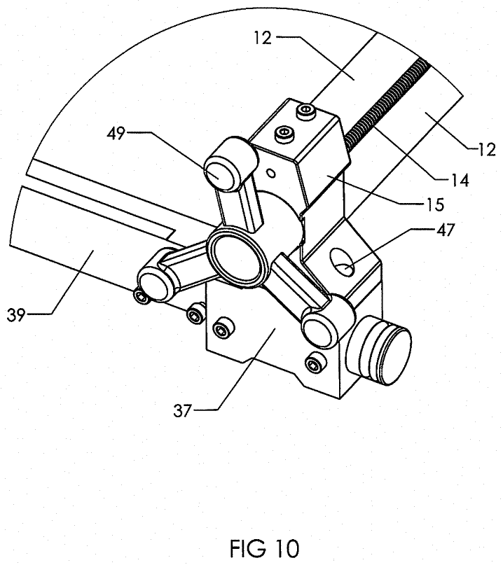

In addition to the stiffening frame assembly, FIG. 10 shows an embodiment in which any of the ball screw 13A, 13B or 13C are operatively coupled with a manual linear translator actuator in the form of hand knob 49. The hand knob 49—most preferably positioned at the end of the ball screw opposite to the motor—can be rotated in order to rotate the ball screw and move the traversing blocks 19A and 19B. This configuration can be used when it is desired to calibrate the position of the CNC machine, its linear rails, or its cutting tool. It can also be used to operate the CNC machine. Although shown in association with the stiffening frame assembly, the manual actuator can be used in other embodiments.

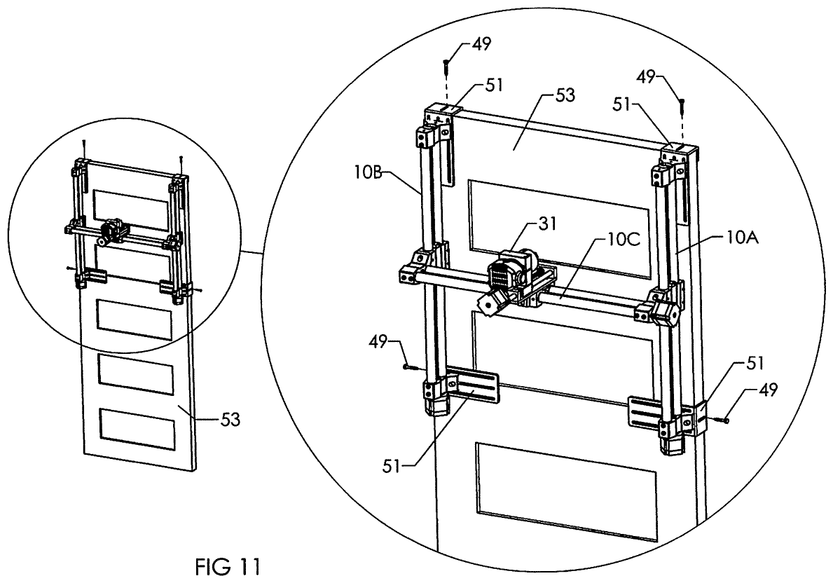

FIG. 11 shows an embodiment of the invention in which the compound frame assembly 8 is attachable to a door 53. Such an embodiment could be employed, for example, to facilitate the use of the CNC machine on a door while the door is installed. This may be desirable, for example, when it is desired to apply a design to the door without removing the door from the hinges. In this embodiment, frame ends 15A and 15B are fastened by door mounting bracket screws 49 to door mounting brackets 51. Preferably, the mounting brackets are shaped and positioned to grip the door 53 as shown in FIG. 11. Door mounting brackets 51 can be mounted either on top of the door (so that the CNC machine hangs from those top-of-door brackets, or around the sides of the door, to hold the CNC machine steady. FIG. 11 shows a pair of each kind of mounting bracket 51.

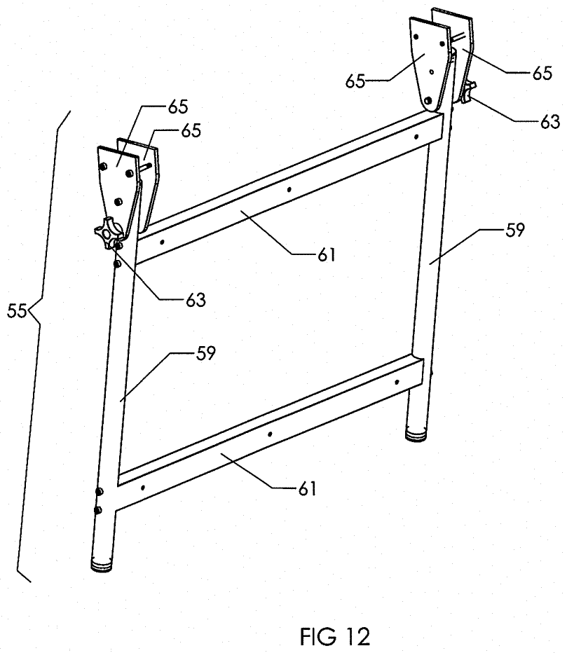

FIGS. 12-14 show a folding leg assembly. In this preferred embodiment, the folding leg assembly 55 can be used to support the CNC machine. Each folding leg assembly 55 provides four legs, with each assembly comprising a folding leg assembly element having two legs. Each assembly 55 includes legs 59, preferably in the form of steel tubing, and cross braces 61, each one fastened to two legs 59.

Each assembly element further includes two folding leg mounting brackets 65, to which stiffening frame assembly 36 or compound frame assembly 8 may be mounted. Associated with each mounting bracket 65 is folding leg lock 63. Folding leg lock 63 has a position in which the legs are locked in a deployed position, and another position in which the leg may be folded up for stowage or transport of the CNC machine with leg assemblies. In the preferred embodiment, lock 63 locks the legs when inserted (as shown) and unlocks them when withdrawn.

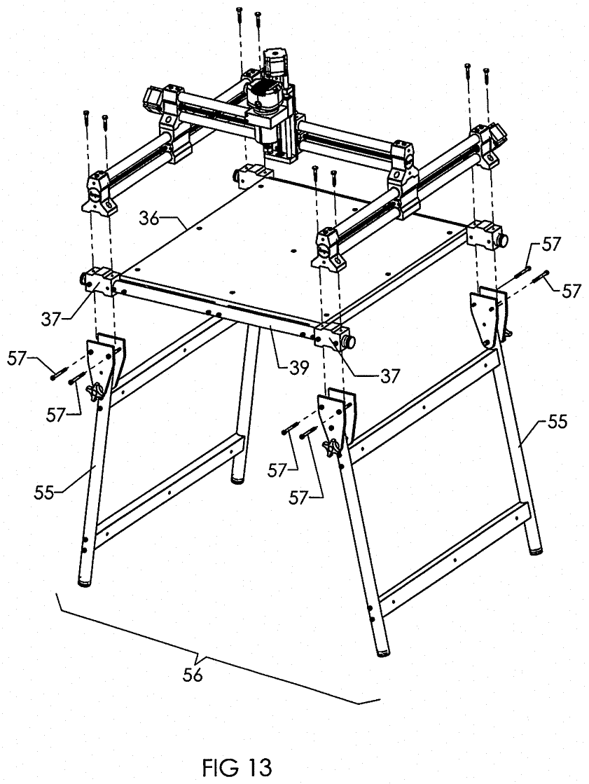

Stiffening frame assembly 36 is configured to be fastened to folding leg mounting brackets 65 by means of folding leg mounting screws 57 attaching connecting blocks 37 to mounting brackets 65. The compound frame assembly 65 is then mounted to the stiffening frame assembly 36 as described previously. In an alternated embodiment, frame ends 15 and brackets 65 may be configured such that frame ends 15A and 15B are fastened directly in brackets 65. However, this alternative may result in less rigidity for the compound frame assembly than the embodiment shown in FIG. 13.

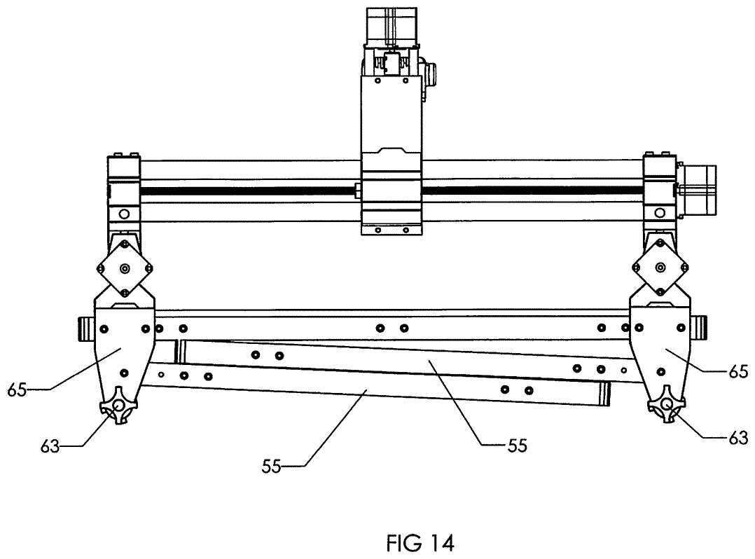

FIG. 14 shows the folding leg assembly with legs 55 folded up conveniently under the CNC machine. In FIG. 14, the locks 63 are quick release connectors. Thus, they are pulled outward to unlock the legs, the legs are folded/retracted, and then the locks 63 are released, and their spring loading causes them to move back into the locking position to hold the legs in the retracted position.

The embodiment of FIGS. 12-14 makes it easy for the CNC machine to be moved from one place to another. In this embodiment, there is no need to disassemble the machine at all. Rather, the legs 55 may be folded, and the entire folding leg assembly, stiffening frame assembly and CNC machine may be transported by carrying or rolling (see below) without any disassembly of those items from one another.

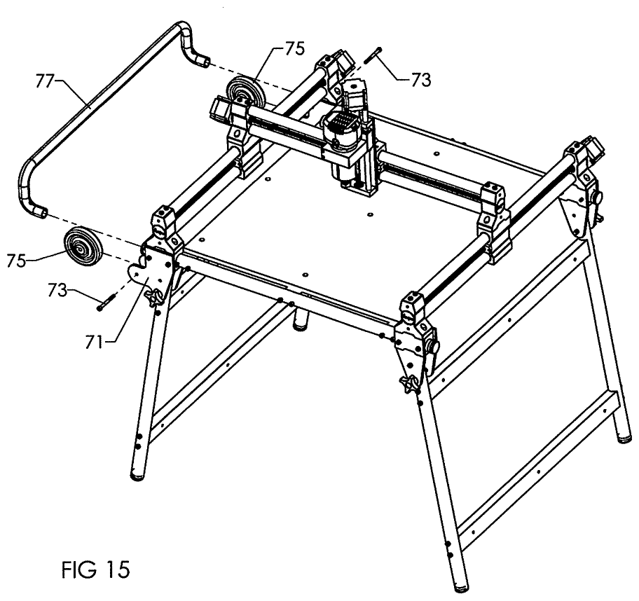

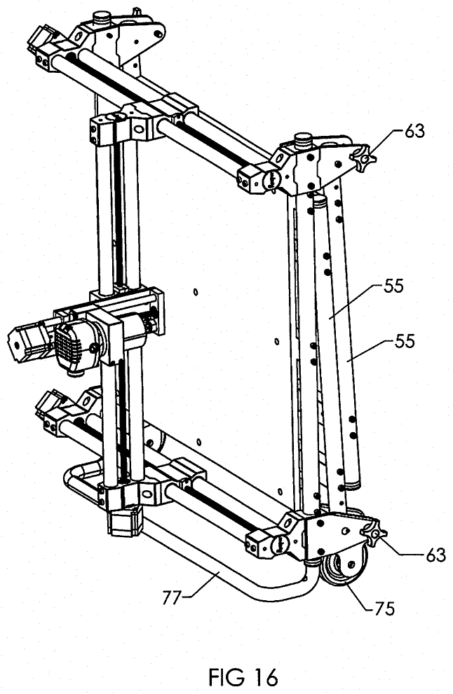

FIGS. 15 and 16 show an embodiment similar to that shown in FIGS. 12-14, but with additional elements facilitating easy storage/stowage and transport of the CNC machine. In this embodiment, two of the mounting brackets comprise wheel mounting brackets 71, configured to mount wheels 75 at two corners of the folding leg assembly 55. Wheels 75 are mounted to brackets 71 by means of wheel mounting screws 73, with the wheels and mounting screws configured such that the screws act as axles around which the wheel rotates. The brackets 71 preferably have two flanges forming a wheel space in which the wheel is positioned.

Stand 77 is mounted along one side of stiffening frame assembly 36 and folding leg assembly 55. It is configured such that when the legs are folded and the CNC machine and stiffening frame are turned on their edge, the weight of the machine and frame leans on the stand to allow the entire thing to stand vertically. This position is shown in FIG. 16. This provides for convenient storage and of the machine in narrow spaces. As shown is FIG. 16, the machine can be transported by pulling on the frame causing the whole machine to be carried by the wheels rolling on the floor. In addition, apart from the wheel, stand 77 can also be used as a handle. Stand 77 can be grasped by hand and the machine lifted. A convenient way of lifting and moving the machine, in its folded up and retracted state is provided. The machine can be moved and be conveniently deployed by unfolding the legs, without disassembly.

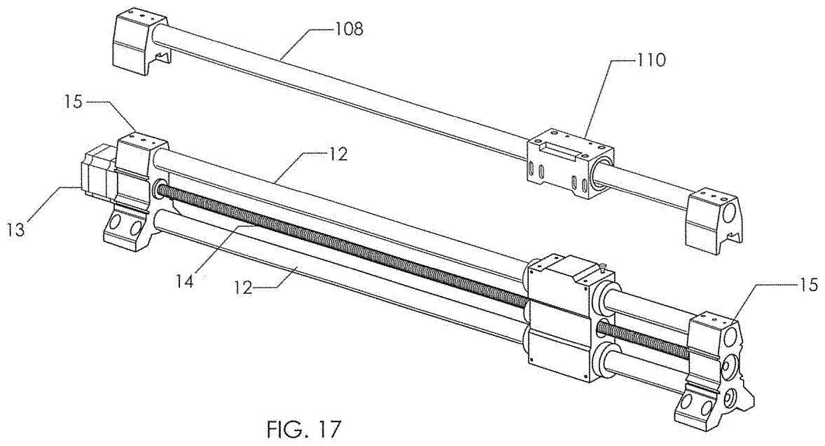

Referring now to FIG. 17, one of the linear rail assemblies is shown. Also shown is a detachably attachable stiffening rod 108. The rod 108 may be attached to further stiffen/rigidify the rail assembly when desired. The stiffening rod preferably has, mounted thereto, a traversing block extension 110 which engages with the traversing block and as a result, moves with it along the rail assembly.

It will be appreciated by those skilled in the art that by virtue of its features, the disclosed CNC machine may be modified and upgraded in various ways. For example, to increase or decrease the size of the machine, shorter or longer rails and ball screws may be substituted for existing ones. The existing ones can be removed from the frame ends, and the new ones substituted.

As mentioned above, deformability in CNC machine frames results is lower than desired precision, because the frame can deflect and cause the cutting to work in a position that is different, due to deformation or deflection, from the nominal position according to the controller. Thus, it is preferred have a rigid structure. In typical CNC support structure and motion guide assemblies, extruded aluminum elements are used. These elements usually require wheels on one of the extrusion surfaces for motion of the spindle, but wheel structures are often deformable. By contrast, in the present invention, metal tubing—preferably steel, is used, and ball screws are used for linear translation. Both of these are less deformable and provide greater rigidity and precision.

In addition, while the tolerances on aluminum extrusions are undesirably wide, with a consequent lowering of precision, the tolerances for steel tubing are significantly narrower, and thus provide greater precision.

Furthermore, the use of steel tubing reducing the number of parts required. For example, wheels and axles are not required for spindle motion, and are replaced in the present invention by simple bushings.

Another feature of some embodiments of the invention is modularity. Assemblies 10A, B and C, which comprise the bulk of the support structure, are preferably interchangeable. As seen in FIGS. 1-5, they are very similar in structure. Among other things, this reduces the cost of producing the CNC machine.

Specifically, the linear rail assemblies 10A, 10B and 10C are of substantially the same structure. Frame ends 15 of each of them, together with frame elements 12 of each of them, provide the support structure of each linear rail assembly. In the preferred embodiment, frame elements 12 are threaded at their ends, and frame ends 15 have corresponding threaded orifices to receive the frame ends. Thus, for example, if it is desired to change the frame elements 12 of an assembly 10 (for example, to substitute longer ones or shorter ones), the elements 12 can be unscrewed from one frame end, and the ball screw would be detached as well. The elements 12 are unscrewed from the other frame end, and the traversing block 19 is slidably removed from the frame elements. New frame elements 12 can now be screwed on to one frame end, then the traversing block 19 placed over the new frame elements with the bearings, and then the second frame end attached to the new frame elements 12. Similarly, if it is desired to replace a ball screw, a frame end and ball screw, and the frame elements, can be detached as just described. The assembly 10 would then be reassembled with the new ball screw as described. Thus, assemblies 10A, 10B and 10C are preferably interchangeable. The parts of each of the (including frame ends, frame elements, traversing blocks, block screws mounting screws etc.) are interchangeable with the parts of the others.

Because assemblies 10A, 10B and 10C are interchangeable, when the machine is being assembled, any of the assemblies can be in either of the two Y positions, or in the X position. In fact, it is comprehended that these interchangeable frame assemblies 10 could be configured differently than the preferred structure of two parallel Y-direction assemblies with an X-direction assembly between them. Furthermore, that these frames are interchangeable makes manufacturing simpler and less expensive. It also makes stocking and obtaining related spare parts simpler and less expensive.

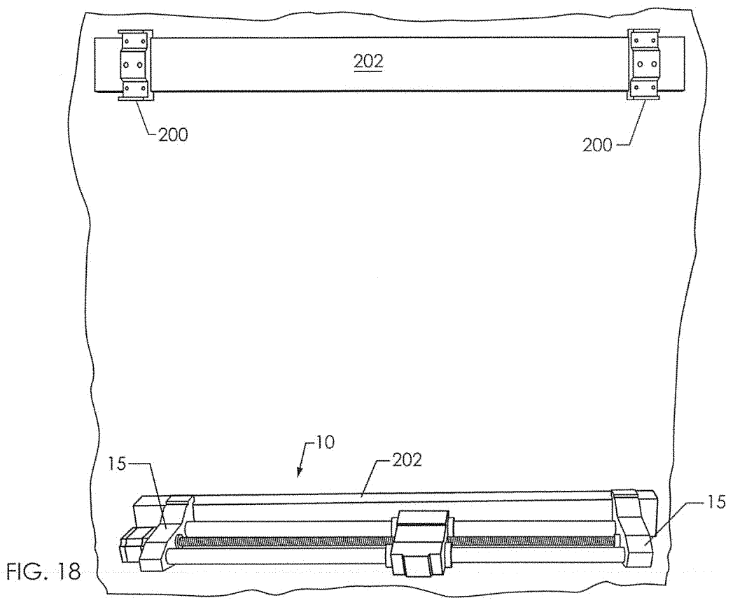

To increase the interchangeability and modularity of the linear rail assemblies 10 and the CNC machine, the preferred assemblies 10 are structure as follows. Having regard to the figures, the assemblies 10 comprise two frame ends 15. Between the ends 15 are at least one, and preferably two frame elements providing the rigid structure of assembly 10. Three or more frame elements are comprehended—see, for example, FIG. 18. Each frame end has a surface fastening feature—preferably holes 96 through which fastening screws 98 fasten the assembly 10 to a surface such as a worktable. Each traversing block also has a frame assembly fastening feature—holes 125 for receiving mounting screws 25. Thus, if the assembly 10 is being used as a Y-direction assembly, the traversing block 19 and holes 125 line up with surface fastening feature holes 96 of the X-direction assembly. The ends 15 of the X-direction assembly 10 are thus fastened to the traversing blocks 19 of the Y-direction assemblies 10. However, the assemblies can be interchanged because they all have the same features. For example, all three traversing blocks 19 are preferably configured with spindle fastening features to permit the spindle to be coupled to the traversing block of whichever assembly 10 is being used as the X-direction frame assembly.

It will be appreciated by those skilled in the art that, particularly when the CNC machine is on a generally horizontal surface, it may not even be necessary fasten the Y-direction assemblies 10 to the surface. Depending on the type of work being done, the type of tool being used, and the weight of the CNC machine, the weight might be sufficient to keep the CNC machine firmly in place. For example, a user may want to use a CNC machine to carve an inlay on a dining room table. It may be impossible to screw the CNC machine into the dining room table without ruining the table, but it may not be required. Each assembly 10 may weigh, for example, 15-25 pounds, and the machine can be positioned on the table and might perform this work without being fastened by screws 98. If the weight is insufficient to hold the machine in place, weights can be added to the assemblies 10 that act as Y-direction assemblies—for example, by placing weights on their frame ends 15 to hold them down more firmly.

It will be appreciated that the preferred configuration of the CNC machine facilitates the transporting and setting up of the machine. It is common in prior art CNC machines for the machine to have an integral frame, and furthermore, for the frame to include the wasteboard. Thus, the machine cannot really be easily dismantled to be moved, and once it is moved, it is hard to set up and square for future use. By contrast, the preferred embodiment of this machine does not have a built in wasteboard or an integral frame. Rather, the support structure is comprised of three assemblies 10. That permits use on various surface and in various orientations, as described elsewhere herein. Furthermore, the preferred embodiment can be easily transported and set up. Specifically, for transport, the controller is unplugged from the machine. The three assemblies 10 are unfastened from one another—the spindle may be left on the X-direction assembly 10. The pieces of the CNC machine, plus the controller described elsewhere herein, can be transported to a new location.

To set up the machine in the preferred manner, two assemblies 10 are lined up roughly parallel to one another as Y-direction frame assemblies. The X-direction frame assembly is mounted to the Y-direction frame assemblies, and moved by hand so that the X-direction frame assembly is positioned at a first end of the two Y-direction frame assemblies. This locates the Y-direction frame ends at the first end, and one screw can be screwed into each of those two first end frame ends of the Y-direction assemblies 10. Using one screw allows each Y-direction frame assemblies 10 to rotate as the set-up continues, and thus allows the second ends to move as needed.

The X-direction frame assembly 10 is then pushed by hand all the way to the second ends of the Y-direction frame assemblies 10, thus locating the second ends. Those second ends can then be fastened in place (e.g. by screws 98), and the fastening of the first ends can be completed. Also, as described above, if no fastening is being done at all, the location of the ends of the Y-direction assemblies to square the device can be performed this way without fastening. The controller can then be plugged in, and the CNC machine is squared and ready to use.

This aspect of the preferred embodiment makes it possible to install the CNC machine even on a vertical surface such as a wall (rather than a horizontal surface like a table). The same basic steps can be taken to fasten the CNC machine so that the X-direction and Y-direction assemblies are parallel to the wall, and the work piece and wasteboard would be positioned against the wall. This can be useful for a user who wants to run a larger number of CNC machines than he is currently running but lacks the horizontal space to do so. Depending of the work being done, such a user might be able to run the extra CNC machines on the walls, thus increasing productivity.

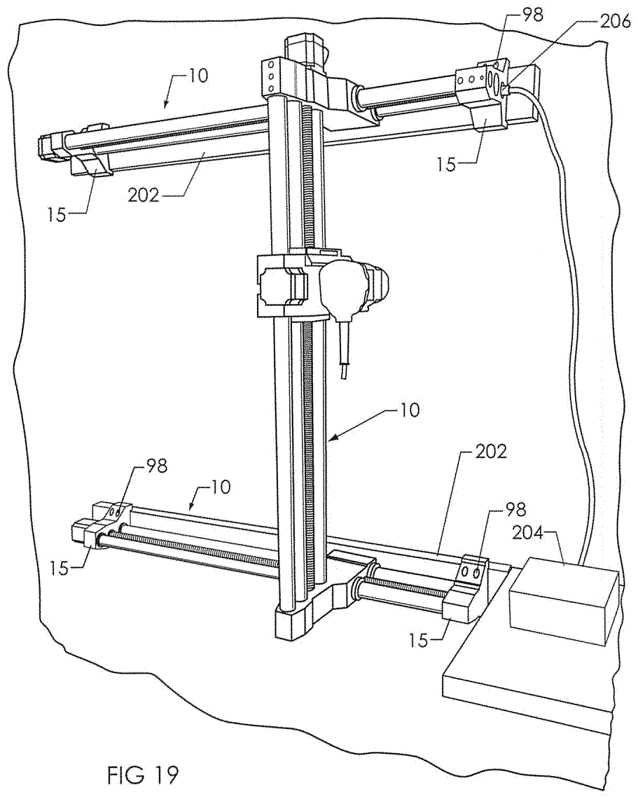

If it is desired to mount the machine to a wall, mounting brackets 200, such as those shown in FIGS. 18-19 might be employed (though they are not necessarily required). The CNC machine would be squared as described above, but the ends of Y-direction assemblies 10 would first be screwed into brackets 200 with screws 98. Then, when the ends of the Y-direction assemblies are located during the squaring process, the bracket bases 202—in the form of two by fours in the embodiment of FIGS. 18-22—would be fastened to the wall. The benefit of this mounting method is that the bases and brackets can be left in place if the CNC machine is moved. When it is desired to put the machine back on the wall, the bases and brackets are already in place and after simply re-mounting the machine it is squared and ready to use.

Thus, the CNC machine of the preferred embodiment may possibly be used on, for example, tables, floor, walls, truck tailgates, trailers, car hoods—a wide variety of surfaces of varying types and orientations.

It is typical for prior art machines to require separate computers. In such configurations, the controller is used to cause operation of the motors to move the machine. It is the separate computer that stores and interprets the computer numerical control code (typically called G-code) and communicates the commands to the controller, which then controls the motors. This greatly increases the cost of the CNC machines, because a computer, usually a laptop, is also required.

Furthermore, the computer is typically positioned in the workshop, which is a harsh environment damaging to the computer.

In the preferred embodiment of the present invention, the controller includes computer functionality to store and interpret G-code, as well as to actuate the motors according to those commands. Thus, when a design is created on a computer (say, in the comfort of the user's home or office), G-code can be generated, and transferred to the preferred controller, for example, by WiFi, USB drive, Ethernet etc. The controller includes one or more processors and associated storage to store and process G-code. This configuration also makes dismantling, moving and setting up the machine easier, as there is no separate computer that needs to be moved.

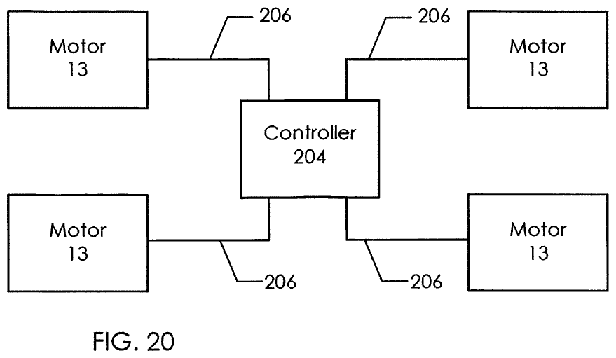

In the preferred embodiment, the controller 204 is coupled, via quick connect wiring 206, to each motor in the CNC machine (in the preferred embodiment, there are four motors—two on the Y-direction assemblies, one on the X-direction assembly, and the fourth to move the Z-direction ball screw). See FIG. 20. This mode of connection is another feature that facilitates disassembly, transport and setup. In the preferred embodiment, to disconnect the controller for the machine, four quick connect plug are disconnected. To set up, the same four need to be connected. The machine is also powered, both for the controller, and in some applications, for the spindle.

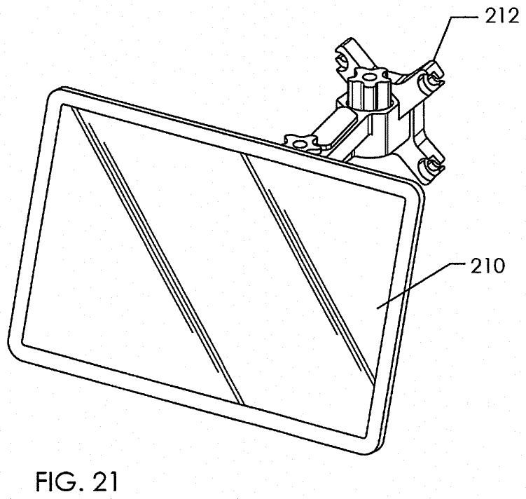

Referring to FIG. 21, the CNC machine may include a controller display 210 with display mount 212. The mount 212 includes a mounting bracket 214 and magnets 26 to mount the display to the bracket 214. The mounting bracket 214 can be mounted to a place on the machine as desired. Preferably, the display (in the form of a tablet) communicates with the controller wirelessly and can be used to enter commands to the controller according to the capability of the controller and display.

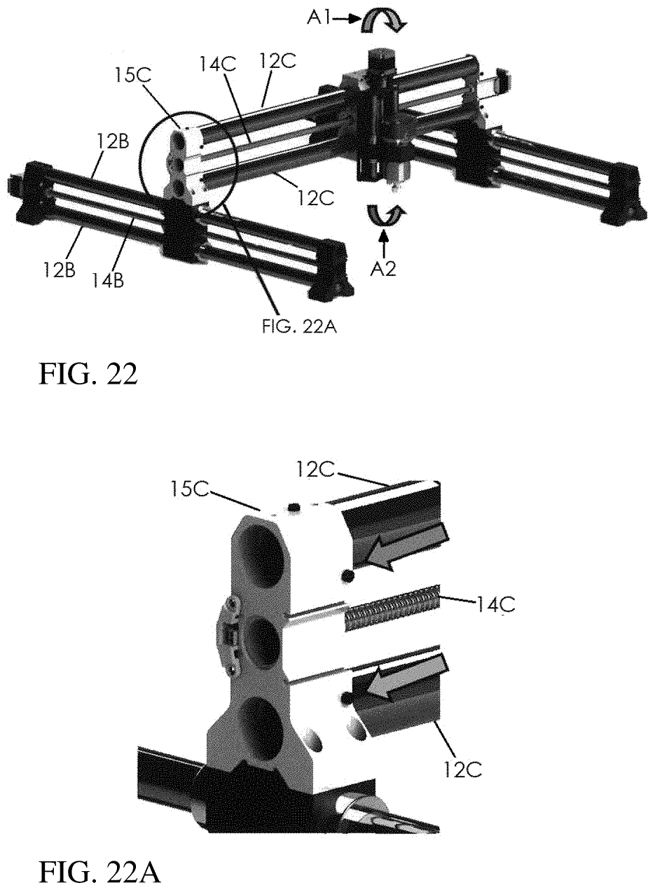

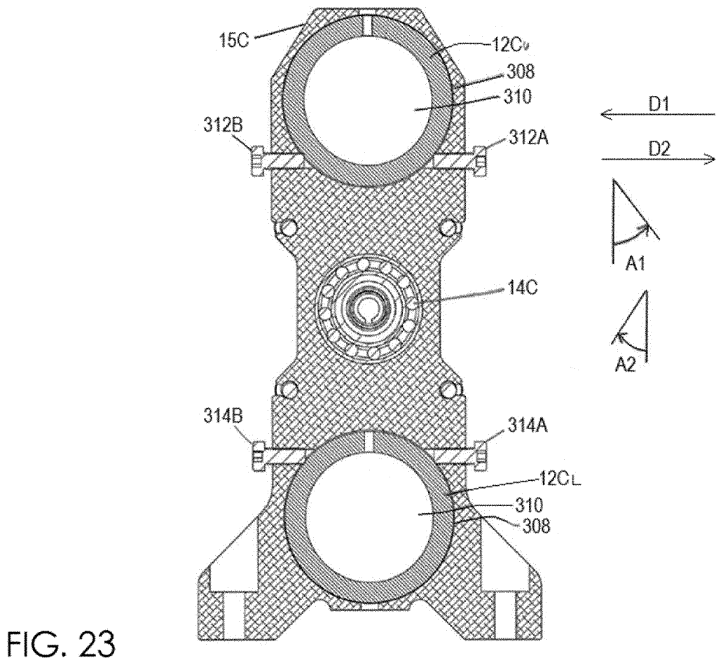

Referring now to FIGS. 22, 22A and 23, an angular adjustment system for the CNC machine is shown. It will be appreciated that the environment in which the CNC machine operates can be a cause of imprecision. Thus, for example, as described above, the machine 8 may operate while resting on a table, and the table may be crooked, lopsided or otherwise imperfect in some fashion. Or, the floor on which the table rests might itself have some significant imperfection. The result might be that either machine 8 or the workpiece may not be positioned or oriented as expected or desired by a user of machine 8. Correcting the shape, position or orientation of, for example, a table or workpiece, may be impractical. If is therefore desirable to be able to adjust the machine 8 to correct for such imprecision.

In an embodiment of the present invention, the angle of traversing block 19C can be adjusted. Since block 19C carries the spindle assembly 31, which carries the cutting tool, adjusting the angle of block 19C adjusts the angle of the cutting tool. This in turn affects the angle and trajectory at which the tool contacts the workpiece.

For ease of description, in FIG. 23, the frame elements 12C are labelled as 12C_{U} (the upper element 12C) and 12C_{L} (the lower element 12C). Elements 12C_{U} and 12C_{L} extend into cavities 310 in blocks 15C, which cavities have edges 308. The blocks secure elements 12C in place as part of the overall machine frame. In the preferred embodiment, there is some play within cavities 310 to permit a small amount of motion of the elements 12C within the blocks 15C in a direction transverse to the longitudinal axes of the elements 12C. In other words, the openings or edges 308 are not precisely the same size as the elements 12C; rather, the openings 308 and associated cavities 310 are larger than elements 12C. In the preferred embodiments, this means that the cavities 310 are generally circular in cross-section and have a larger circumference than the elements 12C, which are also generally circular in cross-section. The result is that the elements can move side to side to some degree within the cavities 310.

It will be appreciated that, in practice, it is impractical for the there to be zero play for the elements 12C within the cavities 310. In a zero-play scenario, it would be practically impossible to insert the elements 12C into the cavities 310. On the other hand, preferably, to have a rigid fame for the CNC machine, play should be limited. In the preferred embodiment, the limited play can be used for fine angle adjustment of the angle of the spindle block 19C, and ultimately, the angle of the tool held by the spindle, relative to the workpiece that is being worked on.

The preferred tool angle adjustment system includes angular adjustment elements 312A, 312B, 314A and 314B. In the preferred embodiment, each of these adjustment elements comprises a screw engaged with threading in block 15C. Each screw is positioned such that it pushes on an element 12C when actuated—preferably, screwed in further, and can push the element 12C against the side of cavity 310 when actuated. Adjustment elements 312A and B are preferably positioned on opposite sides of element 12C_{U} from one another, and can move element 12C_{U} horizontally against one side of cavity 310, or the opposite side. Elements 314A and B preferably have the same arrangement in respect of element 12C_{L}.

In the preferred embodiment, the angle of the spindle and tool can be adjusted by moving the elements 12C_{U} and 12C_{L} relative to one another, preferably in opposite directions. Referring to FIG. 23, if adjustment elements 312A and 314B are actuated, while adjustment elements 312B and 314A are not (i.e. they are unscrewed) to allow the elements 12C to move toward the corresponding side of the corresponding cavity 310, then element 12C_{U} will move in direction D1, element 12C_{L} will move in direction D2, and the spindle and tool will rotate through an angle having the direction of A1. If adjustment elements 312B and 314A are actuated, while adjustment elements 312A and 314B are not to allow the elements 12C to move toward the corresponding side of the corresponding cavity 310, then element 12C_{L} will move in direction D1, element 12C_{U} will move in direction D2, and the spindle and tool will rotate through an angle having the direction of A2. In the preferred embodiment, each of the adjustment elements is present at both ends of each frame element 12C—thus, there are two of each of adjustment elements 312A, 312B, 314A and 314B.

It will be appreciated that the tool angle adjustment system comprehends forms other than the preferred form described above. The system may include one or more angle adjustment actuators, comprising one or more adjustment elements, optionally as described above. The one or more angle adjustment actuators are coupled to the spindle and the tool, and to the frame of the CNC machine. The one or more angle adjustment actuators are actuated to deflect the spindle so as to change the angle of the tool.

By way of example only, the angle adjustment actuator may comprise only angle adjustment elements 312A and B, but not 314A and B. In such a form, the angle of the tool would be adjusted by moving element 12C_{U} in direction D1 or D2. Or, the angle adjustment actuator may comprise only adjustment elements 312A, so as to deflect element 12C_{U} in one direction. In such an embodiment, if adjustment elements 312A were de-actuated (i.e. unscrewed), the force of gravity would adjust the angle of the spindle and tool in the opposite direction.

It will be appreciated that the angle adjustment system comprehends a machine with a frame comprising at least one frame element. The tool is coupled to the frame element. There is at least one angle adjustment actuator, coupled to the frame element, for deflecting the angle of the tool relative to the frame and/or the workpiece upon which the tool works. The angle adjustment system may have some or all of the features of the preferred angle adjustment system described above.

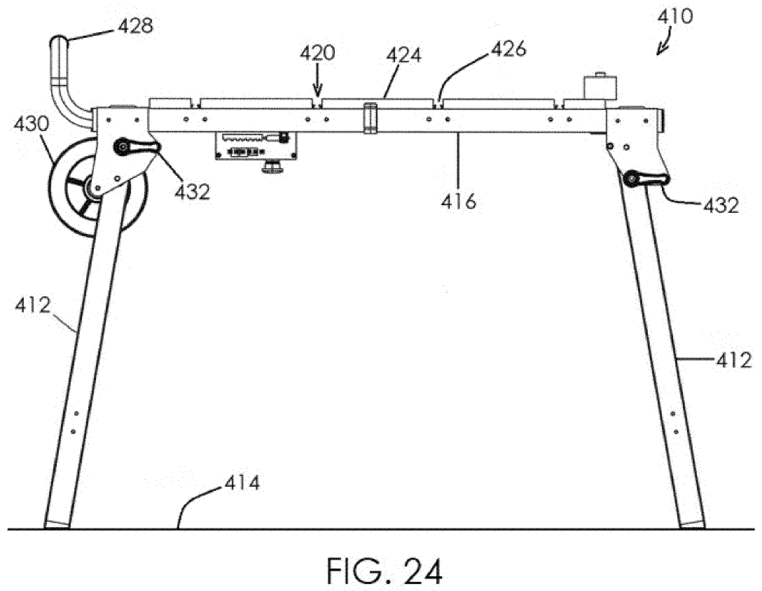

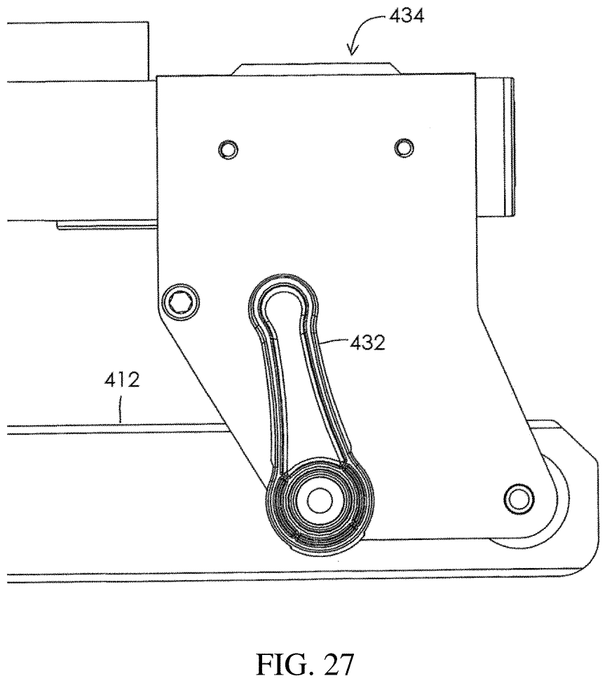

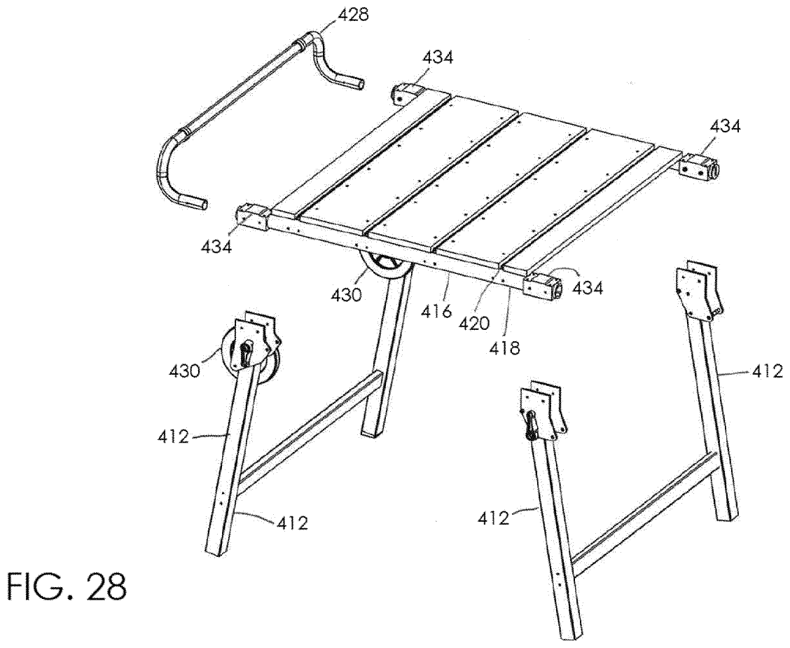

Referring now to FIGS. 24-28, an alternative folding support frame 410 for the machine 8 is shown. This alternative support frame 410 also provides for a convenient means of transporting and using machine 8 in various locations according to the needs and circumstances of the user. The frame 410 preferably has four legs comprising two foldable leg-pairs 412 for supporting the machine 8 on a floor or other surface 414. Leg-pairs 412 are pivotally coupled to horizontal frame 416. In the preferred embodiment, horizontal frame 416 comprises longitudinal frame elements 418 extending between the leg pairs 412, and multiple transverse frame elements 420 extending between elements 418.

Transverse frame elements 420 preferably include screw holes or other fastening facilitators by which waste board 424 can be fastened to the frame 410. In the embodiment of FIGS. 24-28, the waste board 424 is screwed on to elements 420 so as to provide slots 426 between sections of waste board 424. The slots are preferably open at their ends, from the top side of the horizontal frame 416, and from the bottom side of the horizontal frame 416. This configuration allows T-track clamps (not shown) to be used for clamping a work piece to the waste board 424. The clamp is inserted from an end of slot 426 and positioned as desired to hold the workpiece.

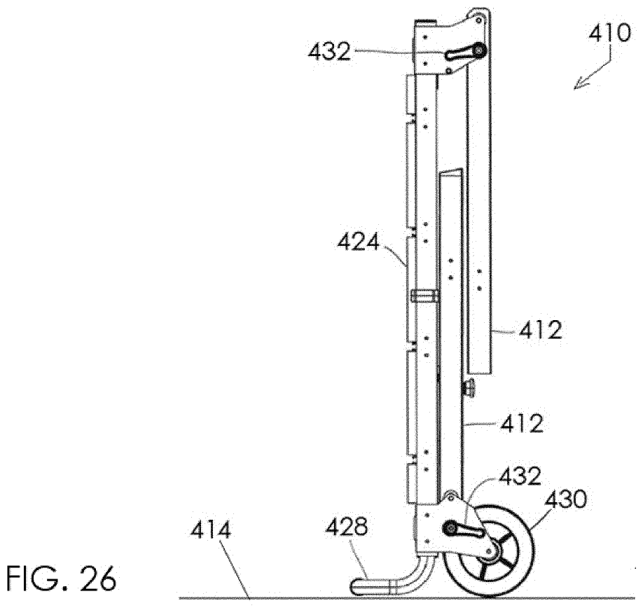

When the legs 412 are folded up (see FIG. 26), the frame 410 may be stored in a narrow space (i.e. short in horizontal directions). As shown in FIG. 26, the frame 410 in its retracted or folded-up state is configured to stand on its end on surface 414. The frame 410 has stand 428 and wheels 430, both of which contact floor 414 to keep frame 410 standing in this retracted storage position. It will be appreciated that stand 428 can be used as a handle to carry frame 410. Meanwhile, wheels 428 (of which there are two, in the preferred embodiment) can be used to roll the frame 410 as needed. A user might hold the frame 410 on the side of frame 410 opposite or distal from the wheels 430, while the wheels 430 are resting on a surface like surface 414. The user can then roll the frame 410 to transport it, by pushing or pulling on it to roll the frame of wheels 430.

In the preferred embodiment, coupled to the leg pairs 412 and the horizontal frame 416 are leg locks 432. Preferably, there are four leg locks 432, positioned at the top of each leg pair. The leg locks 432 each preferably have at least two positions. When moved to the first position, the locks permit the leg pairs 412 to be deployed to the extended position (as shown in FIG. 24) from the folded or retracted position (which is shown in FIG. 26). With the leg locks 432 in that first position, once the leg pairs 412 are moved from the retracted position to the extended position, the leg pairs 412 lock in the extended position. When the locks are moved to the second position, leg pairs 412 may move from the extended or deployed position to the retracted or folded up position, and once they reach that position, they lock in that position. In the embodiment shown in FIGS. 24-28, FIG. 28 shows the locks 432 in the first position. FIG. 26 shows the locks 432 in the second position.

The preferred frame 410 further includes mounting elements 434 rigidly coupled to the horizontal frame 416. The preferred mounting elements 434 are shaped and sized to receive frame ends 15A and 15B so that machine 8 can be mounted on frame 410. Preferred mounting elements 434 include holes 436 that line up with the screw holes in frame ends 15A and 15B. Thus, frame ends 15A and 15B can be fastened to mounting elements 434 by fastening screws through the holes in the frame ends and holes 436, thus rigidly fastening machine 8 to frame 410.

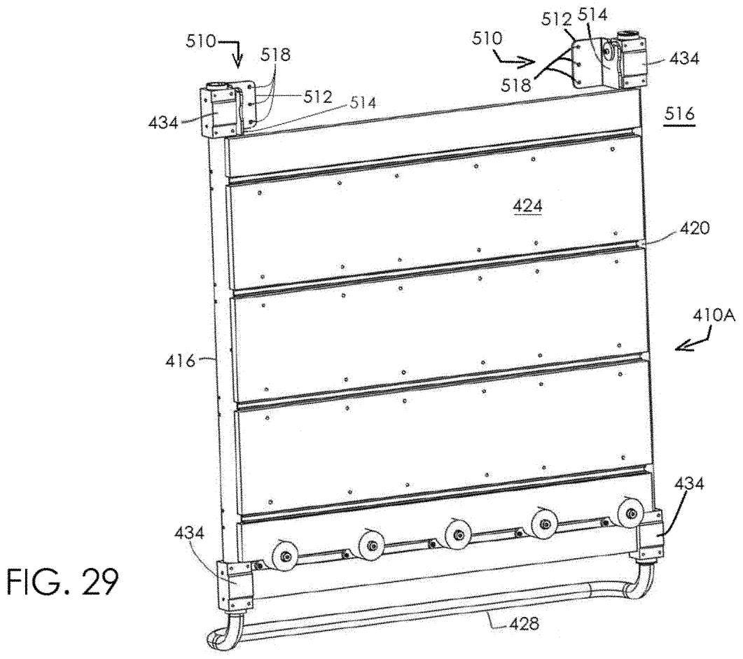

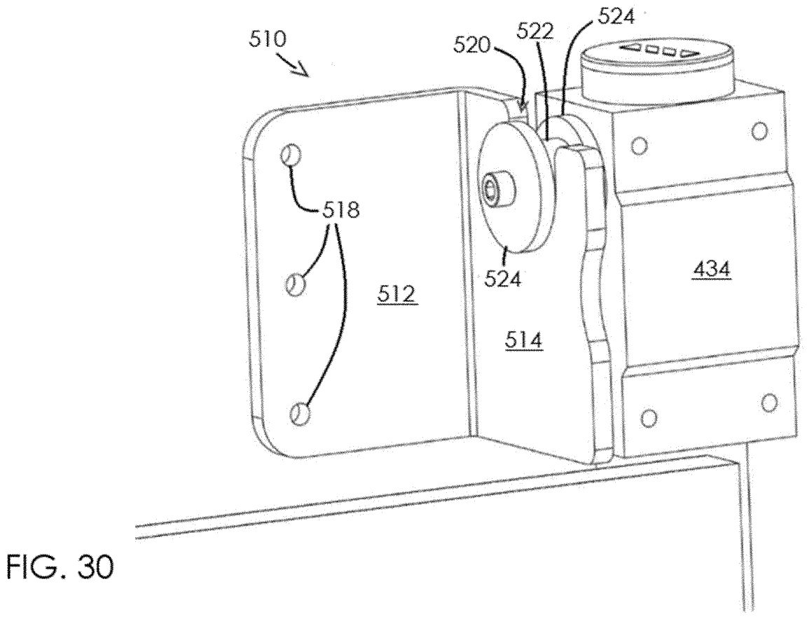

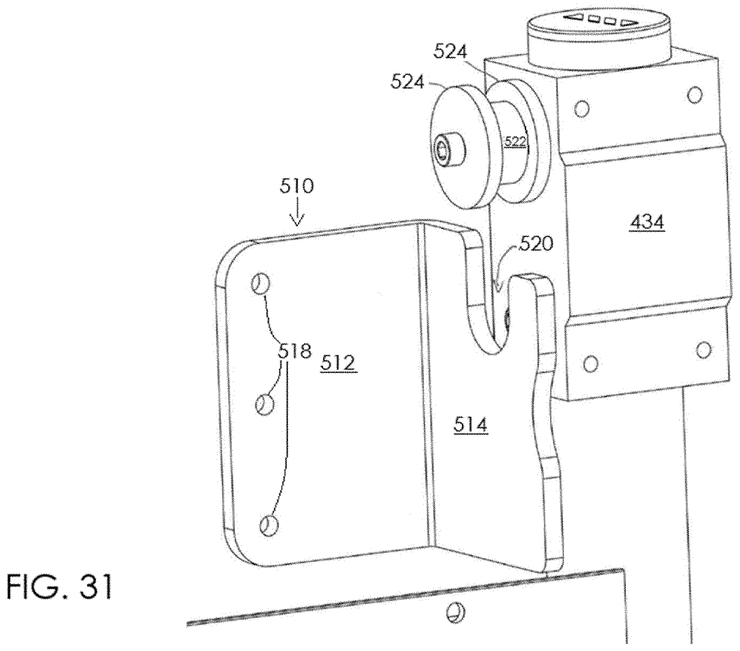

Referring now to FIGS. 29-31, a wall mounted version of frame 410—labelled with reference numeral 410A—is disclosed. The preferred frame 410A includes two brackets 510. Preferably, each bracket 510 has two generally planar portions, namely, wall-mounting portion 512 and frame-supporting portion 514. In the preferred embodiment of this wall-mounting system, the planar portions are oriented generally perpendicularly to one another.

Wall-mounting portions 512 preferably comprise one or more screw holes 518 which are used to rigidly screw brackets 510 into a wall 516 or some other generally vertical or non-horizontal surface (though this system may, if desired, be used on a horizontal surface). The preferred brackets 510 of FIG. 29 have three screw-holes 518.

Portions 514 each have a slot 520 open at its top end to receive a wall mounting feature, which may comprise a wall mounting lug 522. Lug 522 is preferably rigidly coupled to frame 510 via mounting elements 434, without interfering with the features of mounting element 434 which receive the frame ends. In the preferred embodiment, there are two brackets 510, each mating with a lug 522, and coupled to frame 410A via lug 522. Preferably, each lug 522 includes locking flanges 524 which are sized and shaped to lock lug 522 in slot 520 such that lug 522 does not slide out of slot 520 in a horizontal direction. It will be appreciated that the means of locking the frame 510 to the wall mounted brackets to prevent unexpected or undesired detachment may be done by other means besides the preferred means described here.

It will be appreciated that this wall mounting system may be used as follows. Brackets 510 can be fastened to the wall using screws and holes 518. The brackets are fastened in position so that they are the proper width apart to allow lugs 522 to mate with slots 520. Frame 410A is lifted so that lugs 522 are positioned above slots 520. Then, lugs 522 are lowered so as to fit in slots 520, with flanges 524 engaging the bottom end of slot 520 to hold lugs 522 in place, thus holding frame 410A and machine 8 in place.

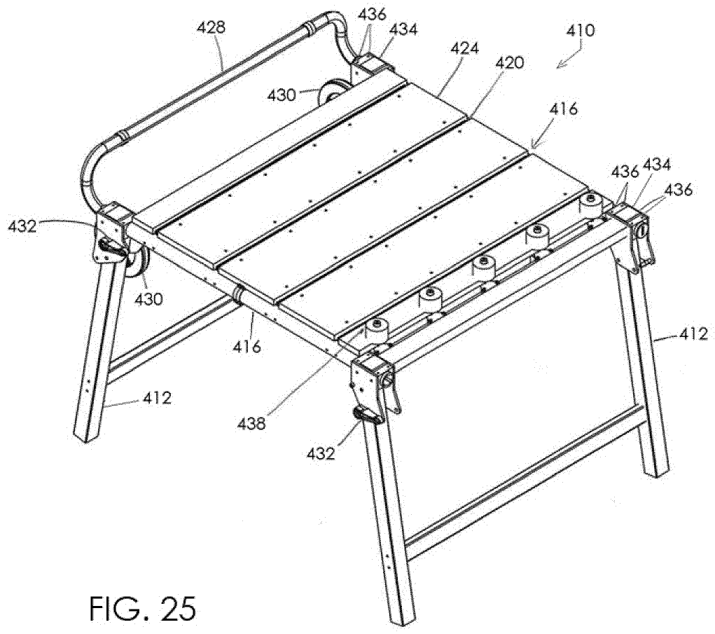

Referring now to FIGS. 25 and 29, the frame 410/410A preferably includes guides, preferably in the form of guide rollers 526 positioned generally linearly along an edge of the frame, and in particular positioned along an edge of waste board 424. The plurality of guide rollers 526 may be positioned along the bottom edge of the wall mounted frame, or along the edge of the frame distal from the wheels 430. It will be appreciated that the guide rollers can be used for positioning a work piece on the waste board. Preferably, the guide rollers 526 have edges that form a straight line, so that when a straight edge of a work piece is rolled along the guide rollers, the position of the edge of the work piece is precisely known.

In the preferred embodiment, the guide rollers are rollably or rotatably mounted to the frame 410/410A. Preferably, they comprise sensors that sense the rotation of the guide rollers, which sensors are operatively connected to the controller. In this way, the guide rollers can be used to provide precise information about the work piece being placed on the waste board.

For example, suppose it is desired to place precisely half a metre of workpiece on to the waste board. An input can be made to the controller indicating the desired length. The edge or corner of a workpiece could be placed at starting point 438, and then moved along guide rollers 526. As guide rollers 526 rotate, and the rotation is sensed, the length of work piece that has been extended on to the waste board is calculated by the controller. Once precisely a half-metre of workpiece has been measured, the controller can signal that the half-metre length has been reached, and the work piece can be cut and/or positioned accordingly.

While the foregoing preferred embodiments of the present invention have been set forth in considerable detail for the purpose of making a complete disclosure of the invention, it will be apparent to those skilled in the art that other embodiments described herein are comprehended by the broad scope of the invention as defined in the appended claims.

1. A Computer Numerical Control (CNC) machine, including a computer numerical controller, the CNC machine comprising:
a tool spindle for holding and actuating a tool for contacting a workpiece;
a support frame comprising at least one frame element carrying the tool spindle;
at least one angle adjustment actuator, coupled to the support frame and the spindle for deflecting an angle of contact of the tool to the workpiece;
a motion actuator for causing movement of the tool spindle and tool; and
an electronic controller for controlling the motion actuator.

2. A CNC machine as claimed in claim 1, the support frame comprising an upper frame element and a lower frame element, the at least one angle adjustment actuator comprising a first angle adjustment actuator for moving the upper frame element and a second angle adjustment actuator for moving the lower frame element.

3. A CNC machine as claimed in claim 2, wherein the first angle adjustment actuator comprises two upper first screws to selectively move the upper frame element in a first direction and two upper second screws to move the upper frame element in a second direction opposite to the first direction.

4. A CNC machine as claimed in claim 3, wherein the second angle adjustment actuator comprises two lower first screws to selectively move the lower frame element in the second direction and two lower second screws to move the lower frame element in the first direction.

5. A CNC machine as claimed in claim 4, wherein the frame elements are held at each end within frame ends, and wherein each screw is actuated within a frame end.

6. A support assembly for supporting a CNC machine, the support assembly comprising:
a support frame, the support frame comprising a CNC machine receiving portion and legs for supporting the CNC machine receiving portion on a surface, the legs having a retracted position and a deployed position; and
at least one lock, coupled to the legs, the at least one lock having a first position in which the legs are movable from the retracted position to the deployed position to lock in the deployed position, and a second position in which the legs are movable from the deployed position to the retracted position to lock in the retracted position.

7. A support assembly as claimed in claim 6, wherein the legs comprise two leg pairs.

8. A support assembly as claimed in claim 7, wherein the at least one lock comprises two locks associated with each leg pair.

9. A Computer Numerical Control (CNC) machine assembly, comprising
a CNC machine including a computer numerical controller;
a support surface;
a linearly arranged plurality of guide rollers rotatably associated with the support surface to rotate in response to a work piece sliding along the linearly arranged plurality of guide rollers; and
sensors associated with the guide rollers to sense the extent of rotation of the guide rollers, the sensors being operatively connected to the controller, wherein the controller calculates a length of work piece sliding along the linearly arranged plurality.

10. A support assembly for supporting a CNC machine, the support assembly comprising:
a support frame, the support frame comprising a CNC machine receiving portion for supporting a CNC machine in a wall-mounted position; and
at least one bracket having wall mounting features for rigid mounting of the bracket to a wall;
the support frame comprising a bracket mating feature to mate with the at least one bracket;
whereby a CNC machine may be supported in a wall-mounted position.
